(19) United States
(12) Patent Application Publication
(10) Pub. No.: US 2020/0063648 A1
(43) Pub. Date: Feb. 27, 2020

(54) Supercharging Device for an Internal Combustion Engine of a Motor Vehicle, and Method for Operating a Supercharging Device of This Kind

(71) Applicant: Bayerische Motoren Werke Aktiengesellschaft, Muenchen (DE)

(72) Inventor: Josef GEROLD, Muenchen (DE)

(21) Appl. No.: 16/671,346

(22) Filed: Nov. 1, 2019

Related U.S. Application Data
(63) Continuation of application No. PCT/EP2018/061130, filed on May 2, 2018.

(30) Foreign Application Priority Data
May 10, 2017 (DE) 10 2017 207 878.2

(51) Int. Cl. F02B 37/14; F02D 41/00; F02B 37/04; F02B 39/10; F01D 15/10

(52) U.S. Cl. CPC F02B 37/14; F02D 41/0007; F02B 37/04; F05D 2220/76; F01D 15/10; F02D 2200/10; F05D 2220/40; F02B 39/10

(57) ABSTRACT

A supercharging device for an internal combustion engine of a motor vehicle includes: an exhaust-gas turbocharger having a turbine wheel that can be driven by exhaust gas from the internal combustion engine and a first compressor wheel that can be driven by the turbine wheel, by which first compressor wheel air being supplied to the internal combustion engine is compressed; an electric compressor having an electric machine and a second compressor wheel that can be driven by the electric machine, by which second compressor wheel air being supplied to the internal combustion engine is compressed; and an overrun air recirculation device associated with the first compressor wheel, by which, when there is a reduction in load on the internal combustion engine, a portion of the air compressed by the first compressor wheel can be branched off at a first point arranged downstream of the first compressor wheel and can be fed back from the first point to a second point arranged upstream of the first compressor wheel, wherein the supercharging device supplies the second compressor wheel with the branched-off air such that the second compressor wheel and, via the second compressor wheel, the electric machine, can be driven by the branched-off air.

### CROSS REFERENCE TO RELATED APPLICATIONS

This application is a continuation of PCT International Application No. PCT/EP2018/061130, filed May 2, 2018, which claims priority under 35 U.S.C. §119 from German Patent Application No. 10 2017 207 878.2, filed May 10, 2017, the entire disclosures of which are herein expressly incorporated by reference.

### BACKGROUND AND SUMMARY OF THE INVENTION

The invention relates to a supercharging device for an internal combustion engine of a motor vehicle and to a method for operating a supercharging device of said type.

A supercharging device for an internal combustion engine of a motor vehicle, and a method for operating a supercharging device, are for example already known from DE 10 2015 216 685 B3. The supercharging device comprises at least one exhaust-gas turbocharger, which at least one exhaust-gas turbocharger has a turbine wheel, which is drivable by exhaust gas of the internal combustion engine, and a first compressor wheel, which is drivable by the turbine wheel. The first compressor wheel is provided for compressing air to be fed to the internal combustion engine. The compressed air is also referred to as charge air.

The supercharging device furthermore comprises at least one electric compressor, which is also referred to as an electrically driven compressor or an electrically drivable or operable compressor. The electric compressor comprises an electric machine and a second compressor wheel which is drivable by the electric machine. By virtue of the second compressor wheel being driven, air to be fed to the internal combustion engine is compressed by means of the second compressor wheel. The electric machine is thus operable for example as an electric motor, by means of which the second compressor wheel can be driven or is driven.

Furthermore, an overrun air recirculation device is provided which is assigned to the first compressor wheel and by which, in the event of a load reduction of the internal combustion engine, at least a part of the air compressed by way of the first compressor wheel can be branched off at a first point arranged downstream of the first compressor wheel and can be returned from the first point to a second point arranged upstream of the compressor wheel. In particular, the branched-off compressed air is expanded by the overrun air recirculation device and can be recirculated by the first compressor wheel or is recycled via the first compressor wheel, such that the branched-off air, after being returned to the second point, can be compressed by the first compressor wheel again.

It is an object of the present invention to create a supercharging device and a method of the type stated in the introduction such that particularly efficient operation can be realized.

A first aspect of the invention relates to a supercharging device for an internal combustion engine of a motor vehicle, in particular of a motor car, for example of a passenger motor car. The supercharging device comprises at least one exhaust-gas turbocharger, which at least one exhaust-gas turbocharger has a turbine wheel, which is drivable by exhaust gas of the internal combustion engine, and a first compressor wheel, which is drivable by the turbine wheel. Air to be fed to the internal combustion engine, in particular to at least one combustion chamber of the internal combustion engine, can be compressed by way of the first compressor wheel. The compressed air is also referred to as charge air.

The supercharging device furthermore comprises at least one electric compressor, which is also referred to as an electrically driven compressor or an electrically drivable or operable compressor. The electric compressor comprises an electric machine and a second compressor wheel which is drivable by the electric machine. By virtue of the second compressor wheel being driven, air to be fed to the internal combustion engine, in particular to at least one combustion chamber of the internal combustion engine, is compressed by means of the second compressor wheel.

The supercharging device furthermore comprises an overrun air recirculation device which is assigned to the first compressor wheel and by which, in the event of a load reduction of the internal combustion engine, at least a part of the air compressed by the first compressor wheel can be branched off at a first point arranged downstream of the first compressor wheel and can be returned from the first point to a second point arranged upstream of the first compressor wheel.

The electric machine is operable for example in a motor mode and thus as an electric motor, by way of which the second compressor wheel can be driven. The above-stated load reduction of the internal combustion engine is for example also referred to as a load dump. During a load dump of said type, a load provided by the internal combustion engine for driving the motor vehicle is reduced, in particular in sudden or abrupt fashion. In other words, for example, the load provided by the internal combustion engine initially has a first value. During the load dump or the load reduction, the first value is reduced to a second value lower than the first value, or the load is reduced from the first value to the second value. This is performed for example by virtue of a throttle flap being at least partially closed. By means of the throttle flap, it is for example possible for a quantity of air to be fed to the internal combustion engine to be adjusted. So-called compressor surging of the first compressor wheel can be avoided by use of the overrun air recirculation device.

To now be able to realize operation of the internal combustion engine, and thus of the motor vehicle as a whole, which is particularly efficient and thus involves particularly little energy consumption, in particular little fuel consumption, provision is made according to the invention whereby the supercharging device is designed to supply the branched-off air to the second compressor wheel such that the second compressor wheel, and via this the electric machine, can be driven by the branched-off air. The concept according to the invention is thus that of not allowing the branched-off air to be lost without being utilized, but rather utilizing said air to drive the second compressor wheel and the electric machine.

In the case of conventional internal combustion engines, provision is made whereby the branched-off, compressed air is returned and at the same time expanded by way of the overrun air recirculation device, such that the air initially compressed by the first compressor wheel and then expanded can be circulated or recycled via the first compressor wheel. The branched-off air can thus, after being returned to the second point, be compressed by means of the first compressor wheel again. Energy contained in the branched-off air, which is contained in the branched-off air owing to the fact that the branched-off air has been compressed by means of the first compressor wheel, is conventionally lost without being utilized, which can however now be avoided according to the invention.

Here, it has proven to be particularly advantageous if the electric machine can be driven by the branched-off air via the second compressor wheel and is thus operable as a generator, by which mechanical energy provided by the second compressor wheel can be converted into electrical energy. In other words, the electric machine is operable in the stated generator mode and thus as a generator. Since the second compressor wheel is driven by the branched-off air at least in one operating state of the internal combustion engine, the second compressor wheel provides mechanical energy, in particular via a shaft that can be driven by the second compressor wheel. Here, the generator or the electric machine is supplied with mechanical energy provided by the compressor wheel, wherein the generator is driven by the mechanical energy. The generator converts at least a part of the mechanical energy into electrical energy and provides said electrical energy that has been obtained from the mechanical energy. Consequently, it is for example possible for at least one electrical consumer of the motor vehicle to be supplied, in particular at least substantially directly, with the electrical energy provided by the generator. Alternatively or additionally, it is contemplated for the electrical energy provided by the generator to be fed into at least one energy store, in particular into a battery, and thus stored in the energy store.

Here, it has proven to be particularly advantageous if the electric machine, in its motor mode, can be supplied and thus operated with electrical energy stored in the energy store. Thus, energy contained in the branched-off compressed air can be utilized for operating the electric machine in the motor mode and thus for compressing the air, such that particularly energy-conserving operation can be realized.

In the case of a supercharging device according to the invention, it is thus possible for at least a part of the energy contained in the air compressed by way of the first compressor wheel to be recovered, and for a load pressure depletion to be performed particularly quickly, such that compressor surging of the first compressor wheel can be reliably prevented. For this purpose, in the event of the stated load dump, the second compressor wheel is flowed through from a high-pressure side to a low-pressure side by the branched-off air.

The compressor wheels are arranged for example in an intake tract which can be flowed through by the air and by means of which the air is fed to the internal combustion engine or to the respective combustion chamber. Here, it is for example the case that the overrun air recirculation device comprises at least one return line which is fluidically connected to the intake tract at the stated points. In this way, at least a part of the air compressed by the first compressor wheel can be branched off from the intake tract, and introduced into the return line, at the first point. The branched-off air can flow through the return line and is conducted by way of the return line from the first point, arranged downstream of the first compressor wheel, to the second point, arranged upstream of the first compressor wheel. At the second point, the air flowing through the return line can flow out of the return line and into the intake tract. In order to now for example utilize the branched-off air for driving the electric machine, it is for example the case that the second compressor wheel is arranged in the return line.

In a further advantageous embodiment of the invention, in a first operating state, the branched-off air flows through the return line in a first direction, whereby the branched-off air is returned from the first point to the second point. In the first operating state, therefore, at least a part of the air compressed by means of the first compressor wheel is branched off from the intake tract.

In a second operating state, in which the second compressor wheel compresses the air for feeding to the internal combustion engine, the air for feeding to the internal combustion engine flows through the return line in a second direction opposite to the first direction and is compressed by way of the second compressor wheel. In other words, in the first operating state, the second compressor wheel and, via this, the electric machine are driven by way of the branched-off air, whereby, for example, the second compressor wheel is rotated about an axis of rotation in a first direction of rotation and the electric machine is operated in its generator mode. In the second operating state, however, the second compressor wheel is driven by the electric machine, in particular in its motor mode, and is thus rotated about the axis of rotation in a second direction of rotation which is opposite to the first direction of rotation, whereby the air is compressed by means of the second compressor wheel. In the first operating state, the second compressor wheel functions as a turbine or as a second turbine wheel, by means of which the electric machine is driven.

To be able to realize a flow of the air which is particularly in accordance with demand and in particular a switchover between the first operating state and the second operating state in accordance with demand, provision is made, in a particularly advantageous embodiment, of a valve device by which respective flows of air through the return line are adjustable.

A second aspect of the invention relates to a method for operating a supercharging device for an internal combustion engine of a motor vehicle, in particular of a motor car such as for example a passenger motor car. Here, the supercharging device comprises at least one exhaust-gas turbocharger, which at least one exhaust-gas turbocharger has a turbine wheel, which is drivable by exhaust gas of the internal combustion engine, and a first compressor wheel, which is drivable by the turbine wheel. The first compressor wheel is provided for compressing air for feeding to the internal combustion engine. The supercharging device furthermore comprises at least one electric compressor which has an electric machine and a second compressor wheel which is drivable by the electric machine. The second compressor wheel is provided for compressing air for feeding to the internal combustion engine. Also provided is an overrun air recirculation device which is assigned to the first compressor wheel and by which, in the event of a load reduction of the internal combustion engine, at least a part of the air compressed by means of the first compressor wheel is branched off at a first point arranged downstream of the first compressor wheel and is returned from the first point to a second point arranged upstream of the first compressor wheel.

To now be able to realize particularly efficient and thus energy-conserving operation, provision is made according to the invention whereby, in at least one operating state, the branched-off air is supplied to the second compressor wheel such that the second compressor wheel, and via this the electric machine, are driven by the branched-off air. Advantages and advantageous embodiments of the first aspect of the invention are to be regarded as advantages and advantageous embodiments of the second aspect of the invention and vice versa.

In the context of the second aspect of the invention, it has proven to be particularly advantageous if the electric machine is driven by the branched-off air via the second compressor wheel and is thus operated as a generator, which converts mechanical energy provided by the compressor wheel into electrical energy and provides the electrical energy.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of a supercharging device according to the invention as per a first embodiment for an internal combustion engine of a motor vehicle.

FIG. 2 is a schematic illustration of the supercharging device according to the invention as per a second embodiment.

In the figures, identical or functionally identical elements are denoted by the same reference designations.

### DETAILED DESCRIPTION OF THE DRAWINGS

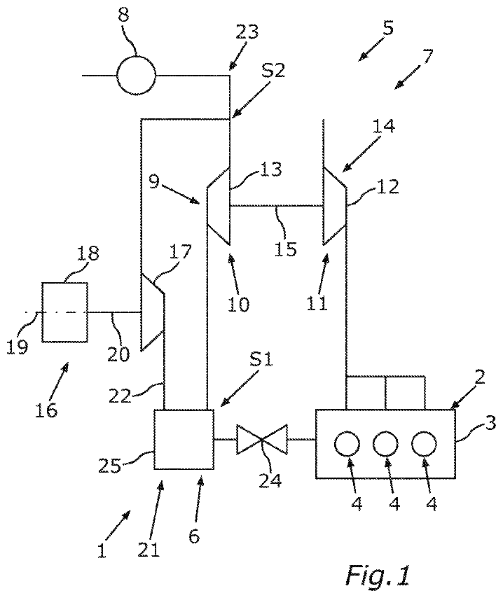

FIG. 1 shows, in a schematic illustration, a first embodiment of a drive device, denoted as a whole by 1, for a motor vehicle, in particular for a motor car such as for example a passenger motor car. Here, the drive device 1 comprises an internal combustion engine 2, which is designed for example as a reciprocating-piston engine. The internal combustion engine 2 has an engine housing 3 which is formed for example as a cylinder housing, in particular as a cylinder crankcase, and by means of which multiple combustion chambers 4 in the form of cylinders are formed. Furthermore, the drive device 1 comprises a supercharging device 5, by means of which the internal combustion engine 2, in particular the combustion chambers 4, can be supplied with compressed air. Here, the drive device 1, in particular the supercharging device 5, comprises an intake tract 6 which can be flowed through by air and by means of which the air can be conducted to and in particular into the combustion chambers 4. The internal combustion engine 2 can thus be supplied with said air by way of the intake tract 6. The combustion chambers 4 are supplied with air compressed by the supercharging device 5 and with fuel, in particular liquid fuel, for the operation of the internal combustion engine 2, such that a fuel-air mixture forms in the respective combustion chamber 4. The fuel-air mixture is burned, resulting in exhaust gas of the internal combustion engine 2. Here, an exhaust tract 7 is provided which can be flowed through by the exhaust gas of the internal combustion engine 2 and by which the exhaust gas can be discharged from the combustion chambers 4. In the intake tract 6, there is arranged an air filter 8 by which the air that has initially not yet been compressed is filtered.

The supercharging device 5 comprises at least one exhaust-gas turbocharger 9, which has a compressor 10 arranged in the intake tract 6 and a turbine 11 arranged in the exhaust tract 7. The turbine 11 comprises a turbine wheel 12, which can be driven by the exhaust gas of the internal combustion engine 2. The compressor 10 comprises a first compressor wheel 13, which is arranged in the intake tract 6 and which can be driven by the turbine wheel 12. Here, the turbine wheel 12 and the compressor wheel 13 are constituent parts of a rotor 14 of the exhaust-gas turbocharger 9. The rotor 14 also comprises a shaft 15, by means of which both the compressor wheel 13 and the turbine wheel 12 are connected for conjoint rotation. In this way, the compressor wheel 13 can be driven by the turbine wheel 12 via the shaft 15. By virtue of the compressor wheel 13 being driven, air that is fed to the combustion chambers 4 is compressed by the compressor wheel 13, wherein the compressed air is also referred to as charge air.

Furthermore, an electric compressor 16 is provided which has a second compressor wheel 17 and an electric machine 18. The electric machine 18 has a stator (not shown in FIG. 1) and a rotor which is rotatable about an axis of rotation 19 relative to the stator. Here, the rotor comprises a shaft 20 which is rotatable about the axis of rotation 19 and to which the second compressor wheel 17 is connected for conjoint rotation. Here, the second compressor wheel 17 can be electrically driven by the electric machine 18 via the shaft 20. By virtue of the compressor wheel 17 being driven in this way, the compressor wheel 17 is rotated about the axis of rotation 19, and air that is fed to the combustion chambers 4 is compressed by the compressor wheel 17. For example, the compressor wheels 13 and 17 are connected or arranged in parallel with respect to one another, such that the compressor wheels 13 and 17 can for example be operated in parallel with respect to one another. In particular, it is contemplated for at least a first of the combustion chambers 4 to be supplied with compressed air by the compressor wheel 13 and, in parallel, for at least a second of the combustion chambers 4, which differs from the first combustion chamber, to be supplied with compressed air by the compressor wheel 17.

To be able to prevent the so-called compressor surging of the compressor wheel 13 or of the compressor 10, the first compressor wheel 13 or the compressor 10 is assigned an overrun air recirculation device 21, by which, in the event of a load reduction of the internal combustion engine 2, at least a part of the air compressed by way of the compressor wheel 13 can be branched off from the intake tract 6 at a first point S1 arranged downstream of the first compressor wheel 13 and can be returned from the first point Si to a second point S2 arranged upstream of the first compressor wheel 13. In other words, if for example a load reduction of the internal combustion engine 2 occurs, wherein the load reduction is also referred to as a load dump, then the air compressed by way of the compressor wheel 13 is branched off from the intake tract 6, and is for example introduced into a return line 22 of the overrun air recirculation device 21, at the first point S1. The return line 22 is fluidically connected at the point S1 and S2 fluidically to the intake tract 6, in particular to an air line 23 of the intake tract 6, such that, for example at the point 51, the air compressed by the compressor wheel 13 can flow out of the intake tract 6 or out of the air line 23 and into the return line 22. The branched-off air that flows through the return line 22 is returned from the first point S1 to the second point S2 by means of the return line 22 and can, at the second point S2, flow out of the return line 22 and into the intake tract 6 or into the air line 23. In this way, it is for example the case that the branched-off air is recycled or the branched-off air can recirculate, because the branched-off air can flow from the point S2 to the compressor wheel 13 and be compressed again by means of the compressor wheel 13.

For example, the air is compressed to a charge pressure by the compressor wheel 13. As a result of the air compressed by the compressor wheel 13 being branched off and returned, a depletion of the charge pressure can be realized, such that compressor surging of the compressor 10 can be avoided. The depletion of the charge pressure is also referred to as charge pressure depletion. During the charge pressure depletion, it is for example the case that the branched-off air that flows through the return line 22 is expanded.

Since the internal combustion engine 2 is equipped with the supercharging device 5, the internal combustion engine 2 is also referred to as a turbo engine. In the case of such a turbo engine, it is desirable for a feed of air into the combustion chambers 4 to be reduced as quickly as possible in the event of a load dump, and thus for the abovementioned charge pressure depletion to be performed particularly quickly. The load dump and thus the reduction of the feed of air take place for example by virtue of a throttle flap 24 that is arranged in the intake tract 6 being at least partially closed. Here, the throttle flap 24 is arranged downstream of the compressor wheels 13 and 17 and upstream of the combustion chambers 4 and is utilized to adjust a quantity or mass of the air for feeding to the combustion chambers 4. Here, the charge pressure depletion is performed in front of or upstream of the throttle flap 24 and in particular by way of a backward flow of the air compressed by the compressor wheel 13 for example via the compressor wheel 13 counter to an intake flow direction.

This can conventionally lead to acoustic anomalies, whereby corresponding vehicle requirements can no longer be adhered to. Furthermore, it is conventionally the case that energy contained in the compressed and branched-off air is lost without being utilized. The higher the load pressure in the event of the load dump, the longer the load pressure depletion lasts, and the more likely acoustic anomalies are. For this reason, the overrun air recirculation device 21 is used, which conventionally has an overrun air recirculation valve. By means of the overrun air recirculation device 21, the backflow, provided for the charge pressure depletion, of the air compressed by the compressor wheel 13 via the compressor wheel 13 counter to the intake flow direction can be avoided, because the compressed air can be returned via the return line 22. Here, the branched-off and returned air bypasses the compressor wheel 13, such that the branched-off air that is returned to the point S2 does not flow through or via the compressor wheel 13. However, in the case of conventional supercharging devices utilizing an overrun air recirculation device, energy contained in the branched-off, compressed air is lost without being utilized. This can however now be avoided with the supercharging device 5.

To now realize particularly efficient and energy-conserving operation, the supercharging device 5 is designed to supply the branched-off air to the second compressor wheel 17, such that the second compressor wheel 17 and, via the second compressor wheel 17, the electric machine 18 are drivable or are driven by the branched-off air flowing through the return line 22. In other words, in at least one first operating state, the second compressor wheel 17 is supplied with the air compressed by means of the compressor wheel 13, such that the second compressor wheel 17 and, via the second compressor wheel 17, the electric machine 18 are driven by the branched-off air compressed by the compressor wheel 13.

In the case of overrun air recirculation valves that are conventionally used, the charge pressure depletion is performed by recycling of the charge air via the compressor 10. For this purpose, the compressed charge air is conducted via the overrun air recirculation valve back to the point S2 and is expanded in the process, wherein the point S2 is arranged in a low-pressure region of the intake tract 6. By contrast, the point S1 is arranged in a high-pressure region of the intake tract 6, because a higher pressure prevails at the point S1 than at the point S2. After the return of the compressed air to the point S2, the air is compressed again by means of the compressor 10. Here, the charge pressure depletion takes place relatively slowly, and the energy contained in the air compressed by means of the compressor wheel 13 is not utilized further, or is converted primarily into heat. By contrast, in the case of the supercharging device 5, energy recovery is provided. In the context of the energy recovery, the compressor wheel 17 and, via this, the electric machine 18 are driven by the branched-off air flowing through the return line 22.

In at least one second operating state that differs from the first operating state, the electric machine 18 is operated for example in a motor mode and thus has an electric motor. For this purpose, the electric machine 18 is for example supplied with electrical energy or electrical current that is stored in an energy store not shown in FIG. 1. By operation of the electric machine 18 in the motor mode, the compressor wheel 17 is driven by the electric machine 18 and is thus rotated in a first direction of rotation about the axis of rotation 19, whereby air that flows through the return line 22 is compressed and fed to the combustion chambers 4.

In the abovementioned first operating state, however, the compressor wheel 17 is driven by air that is or has been compressed by means of the compressor wheel 13 and flows through the return line 22. In this way, energy contained in the branched-off air is converted into mechanical energy, which is provided by the compressor wheel 17. In this way, the electric machine 18 is driven by the compressor wheel 17 via the shaft 20. In the first operating state, the electric machine 18 is operated in a generator mode and thus as a generator, which converts at least a part of the mechanical energy provided by the compressor wheel 17 into electrical energy and provides this electrical energy. Here, in the first operating state, the compressor wheel 17 rotates about the axis of rotation 19 in a second direction of rotation that is opposite to the first direction of rotation. Thus, in the first operating state, the compressor wheel 17 functions as a turbine or as a turbine wheel, by means of which the electric machine 18, in particular the rotor or electric machine 18, is driven. By means of the compressor wheel 17, the branched-off air is expanded, which can then flow into the air line 23 at the second point S2 and finally flow back to the compressor wheel 13.

To realize the first operating state, in the event of the load dump, the backed-up charge air is conducted via the compressor wheel 17 and thus via the electric compressor 16 to the low-pressure region and expanded. This is realized for example by means of corresponding valve switching in the intake tract 6. In other words, a valve device 25 is preferably provided by which respective flows of air through the return line 22 and through the air line 23 are adjustable. In other words, it is for example possible by means of the valve device 25 to switch over between the stated operating states, which are also referred to as operating modes.

Altogether, it is evident that, in the event of a load dump, energy in the form of electrical current can be obtained from the charge air compressed by the compressor wheel 13. In relation to a conventional overrun air recirculation valve, it is furthermore possible for disturbing acoustic noises to be avoided or to be kept particularly low, for example because the charge pressure depletion can be performed particularly quickly and advantageously. In particular, the charge pressure depletion can be better controlled in open-loop or closed-loop fashion in relation to conventional overrun air recirculation valves, whereby the generation of undesired noises can be avoided. Thus, with the supercharging device 5, a particularly advantageous recuperation of energy contained in the air compressed by means of the compressor wheel 13, and a particularly fast charge pressure depletion in the event of a load dump, can be realized.

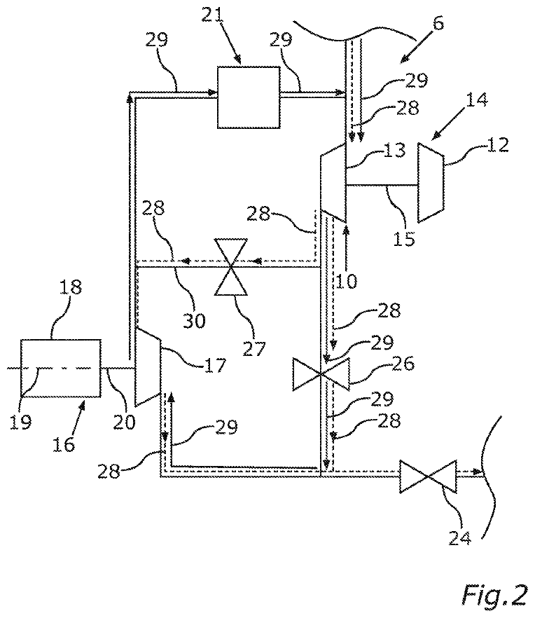

FIG. 2 shows a second embodiment of the supercharging device 5. In the first embodiment, at least a part of the air flowing through the intake tract 6 is branched off in front of the first compressor wheel 13 or upstream of the first compressor wheel 13. The branched-off air or the branched-off part is not compressed by the compressor wheel 13, but is rather fed to the second compressor wheel 17 and compressed by the compressor wheel 17 or by the electrical compressor 16, such that, for example, the compressors 10 and 16 operate in parallel.

In the second embodiment, however, it is for example the case that series operation of the compressors 10 and 16 is provided. For this purpose, in particular in a supercharging mode that is illustrated in FIG. 2 by arrows 28, the air flowing through the intake tract 6 is firstly compressed by means of the compressor wheel 13. At least a part of the air compressed by means of the compressor wheel 13 is fed to the compressor wheel 17 via a line 30 and is compressed once again or further by means of the compressor wheel 17. Here, a check valve 26 ensures that the air compressed by means of the compressor wheel 17 cannot flow back to the first compressor wheel 13. Here, the line 30 is fluidically connected to a first air line, which leads away from the compressor wheel 13, at a point arranged downstream of the compressor wheel 13. Furthermore, the line 30 is fluidically connected to a second air line, which leads to the compressor wheel 17, at a point arranged downstream of the compressor wheel 13. In this way, by means of the line 30, at least the stated part of the air compressed by means of the compressor wheel 13 can be branched off from the first air line and introduced to or into the second air line. The branched-off part is then conducted by means of the second air line to the compressor wheel 17. Here, in particular during the supercharging mode, a valve 27 arranged in the line 30 is opened.

In FIG. 2, arrows 29 illustrate the above-described charge pressure depletion. During the charge pressure depletion, a flow cross section of the intake tract 6 that can be flowed through by the air is at least reduced or at least partially shut off by virtue of the throttle flap 24 being at least partially closed. In this way, the feed of air to the combustion chambers 4 is reduced, in particular in relation to the supercharging mode that precedes the charge pressure depletion. Additionally, the overrun air recirculation device 21, in particular the overrun air recirculation valve thereof, is then opened, and the valve 27 arranged in the line 30 is closed, in order that the air flows via the compressor wheel 17 and thus via the electric compressor 16, such that the electric machine 18 of the electric compressor 16 can be operated in the generator mode in the described manner.

### LIST OF REFERENCE DESIGNATIONS

1 Drive device
2 Internal combustion engine
3 Engine housing
4 Combustion chamber
5 Supercharging device
6 Intake tract
7 Exhaust tract
8 Air filter
9 Exhaust-gas turbocharger
10 Compressor
11 Turbine
12 Turbine wheel
13 First compressor wheel
14 Rotor
15 Shaft
16 Electric compressor
17 Second compressor wheel
18 Electric machine
19 Axis of rotation
20 Shaft
21 Overrun air recirculation device
22 Return line
23 Air line
24 Throttle flap
25 Valve device
26 Check valve
27 Valve
28 Arrow
29 Arrow
30 Line
S1 First point
S2 Second point

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A supercharging device for an internal combustion engine of a motor vehicle, comprising:
at least one exhaust-gas turbocharger having a turbine wheel which is drivable by exhaust gas of the internal combustion engine and a first compressor wheel which is drivable by the turbine wheel and which is provided for compressing air for feeding to the internal combustion engine;
at least one electric compressor having an electric machine and a second compressor wheel which is drivable by the electric machine and which is provided for compressing air for feeding to the internal combustion engine; and
an overrun air recirculation device assigned to the first compressor wheel and by which, in an event of a load reduction of the internal combustion engine, at least a part of the air compressed by the first compressor wheel is branched off at a first point arranged downstream of the first compressor wheel and is returned from the first point to a second point arranged upstream of the first compressor wheel, wherein
the supercharging device is configured to supply the branched-off air to the second compressor wheel such that the second compressor wheel and, via the second compressor wheel, the electric machine, is drivable by the branched-off air.

2. The supercharging device according to claim 1, wherein
the electric machine is driven by the branched-off air via the second compressor wheel and is thus operable as a generator, by which mechanical energy provided by the second compressor wheel is converted into electrical energy.

3. The supercharging device according to claim 1, wherein
the overrun air recirculation device has at least one return line which is flowed through by the branched-off air and in which the second compressor wheel is arranged.

4. The supercharging device according to claim 3, wherein
in a first operating state, the branched-off air flows through the return line in a first direction.

5. The supercharging device according to claim 4, wherein
in a second operating state, in which the second compressor wheel compresses the air for feeding to the internal combustion engine, the air for feeding to the internal combustion engine flows through the return line in a second direction which is opposite to the first direction.

6. The supercharging device according to claim 2, further comprising:
a valve device by which respective flows of air through the return line are adjustable.

7. A method for operating a supercharging device for an internal combustion engine of a motor vehicle, the supercharging device having an exhaust-gas turbocharger with a turbine wheel drivable by exhaust gas and with a first compressor wheel drivable by the turbine wheel, the supercharging device further having an electric compressor with an electric machine and a second compressor wheel drivable by the electric machine, the method comprising the steps of:
in an event of a load reduction of the internal combustion engine, branching-off a portion of air compressed by the first compressor wheel at a first point arranged downstream of the first compressor wheel and returning the air from the first point to a second point arranged upstream of the first compressor wheel; and
in at least one operating state, supplying the branched-off portion of air to the second compressor wheel such that the second compressor wheel and, via the second compressor wheel, the electric machine, are driven by the branched-off air.

8. The method according to claim 7, further comprising the step of:
operating the electric machine as a generator that converts mechanical energy provided by the second compressor wheel into electrical energy, wherein the electric machine is driven by the branched-off portion of air via the second compressor wheel.
